(19) United States
(12) Patent Application Publication
(10) Pub. No.: US 2026/0099865 A1
(43) Pub. Date: Apr. 9, 2026

(54) CHATBOT RECOMMENDATIONS FROM CONVERSATION CONTEXT

(71) Applicant: Snap Inc., Santa Monica, CA (US)

(72) Inventor: Tyrone Ahmad-Taylor, Los Angeles, CA (US)

(21) Appl. No.: 19/417,102

(22) Filed: Dec. 11, 2025

Related U.S. Application Data
(63) Continuation of application No. 18/451,566, filed on Aug. 17, 2023.

(51) Int. Cl. G06Q 30/0251; G06F 40/40; G06Q 30/0241

(52) U.S. Cl. CPC G06Q 30/0271; G06F 40/40; G06Q 30/0277

(57) ABSTRACT

A system and method for facilitating natural language conversations between customers and vendors for product purchases is provided. The system ingests product catalogs from vendors, normalizes the data, and provides a conversational interface for customers to query the catalogs. In some examples, a chatbot system receives a natural language query from a customer about a product in a chat interface, identifies vendors offering that product by searching uploaded product catalogs, determines available inventory for the product by querying the catalogs, and generates a natural language response to the customer using the vendor and inventory information. The system can extract product details from the query, search based on those details, rank and recommend vendors and products, update user profiles, offer purchase incentives, and complete transactions within the conversation. The system handles the conversational and technical aspects to enable natural dialog between businesses and customers regarding products.

### CROSS-REFERENCE TO RELATED APPLICATION

This application is a continuation of U.S. patent application Ser. No. 18/451,566, filed Aug. 17, 2023, which applications and publications are incorporated herein by reference in their entirety.

### TECHNICAL FIELD

The present disclosure relates generally to interactive platforms and more particularly to providing interaction interfaces to users of an interactive platform.

### BACKGROUND

Users access chatbots to access useful information. In some conversations, a user may seek information on products or services that the user is interested in.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system, according to some examples, that has both client-side and server-side functionality.

FIG. 3 is a block diagram of a chatbot system and a dynamic advertisement system, according to some examples.

FIG. 4 illustrates a dynamic advertisement method, according to some examples.

FIG. 5A illustrates a machine-learning pipeline, according to some examples.

FIG. 5B illustrates training and use of a machine-learning program, according to some examples.

FIG. 6 illustrates a compliance system, according to some examples.

FIG. 7 is a diagrammatic representation of a data structure as maintained in a database, according to some examples.

FIG. 8 is a diagrammatic representation of a message, according to some examples.

FIG. 9 is a diagrammatic representation of a machine in the form of a computer system within which a set of instructions may be executed to cause the machine to perform any one or more of the methodologies discussed herein, according to some examples.

FIG. 10 is a block diagram showing a software architecture within which examples may be implemented.

### DETAILED DESCRIPTION

Interactive platforms (e.g., social platforms, social media platforms, eXtended Reality (XR) platforms, messaging platforms, gaming platforms, systems with which a user interacts, and the like) may provide a way for users to access information about products or services. For some users, interaction with an interactive platform may be enhanced by interacting with a chatbot software application designed to simulate human conversation through voice commands or text chats. A chatbot system may employ Natural Language Processing (NLP) and Machine Learning (ML)/artificial intelligence methodologies to understand and interpret a user's input and generate a response. A chatbot can serve multiple uses during a conversation including providing useful information to a user.

With the rise of e-commerce, users increasingly research and purchase products online through interactive platforms. However, navigating the vast array of product choices can be daunting for users. At the same time, businesses seek more effective ways to engage with users and drive sales.

Existing solutions rely on manual efforts to address user product queries. Customer service agents respond to user inquiries via phone, email or chat. However, this is labor-intensive and inefficient. Businesses may also use customer relationship management (CRM) software to track user data. But integrating CRM systems into chat interfaces has proven challenging, especially for small businesses.

Intelligent chat agents have been developed that can understand natural language and respond conversationally. However, these agents lack effective ways to access detailed product data and inventory systems to address consumer queries. This disclosure provides systems and methods to bridge this gap.

By leveraging automated natural language processing and access to product catalogs, a chatbot system can effectively address consumer product queries and drive sales through chat interfaces without costly human agents or complex CRM integrations. The chatbot system provides consumers with a highly intuitive shopping experience.

In some examples, a chatbot system using a dynamic advertisement system allows businesses to directly engage with customers through a chat interface, freeing businesses to focus on more meaningful customer conversations. For instance, by handling common product queries, pricing questions, and transactional processes automatically, the chatbot system reduces the repetitive day-to-day customer service burden on vendor agents.

This frees up vendor staff time and resources to instead focus on:
Building deeper, more meaningful relationships with customers through personalized interactions and conversations in the chat interface.
Having more engaging dialogues about customers'specific needs and interests rather than just answering routine questions.
Providing customized recommendations and offers tailored to what each customer truly cares about.
Developing loyalty and brand affinity through excellent service during conversational interactions.
Handling complex customer issues that require human nuance, empathy and discretion.

The automated handling of high-volume, repetitive customer conversations by the chatbot system liberates vendors to direct their human resources towards deeper, more meaningful dialogues that build lasting customer satisfaction and loyalty. This allows businesses to better focus on rich customer engagement through the conversational commerce experience.

In some examples, a chatbot system provides a chat interface that allows users to interact conversationally as if chatting with another person. However, the chatbot system powers the chat using artificial intelligence. Vendors with products to sell can upload product catalogs containing detailed product data like descriptions, inventory, pricing and availability to the chatbot system.

In some examples, the chatbot system stores the aggregated catalog data from all vendors in an inventory database. When a user submits a query through the chat interface regarding a product, the chatbot system accesses the inventory database to identify vendors with the product and determine availability across catalogs. The chatbot system generates a natural language response to the user query using this data, allowing it to engage in a conversational dialogue.

In some examples, if the user wishes to purchase a product, the chatbot system can complete the transaction entirely within the chat interface using integrated payment processing and fulfillment capabilities. The chatbot system can also use usage data and transaction details to enhance user profiles and generate analytics for vendors.

In some examples, when the chatbot system receives a product query through the chat interface, the chatbot system extracts details about the product using natural language processing. The chatbot system searches the product catalogs to identify vendors with the product, potentially using the extracted query details. The chatbot system may rank the vendors based on factors like relationship with the platform, pricing, availability and shipping speed.

In some examples, the chatbot system checks inventory across the identified vendors by querying their product catalogs. The chatbot system generates a natural language response using the vendor, ranking, and inventory data. The chatbot system provides the response to the user through the chat interface.

In some examples, the chatbot system can recommend additional products based on analysis of the user's current query and profile, indicating related interests. The chatbot system updates the user profile with details extracted from the current query to personalize future recommendations. If no purchase is made, the chatbot system may provide incentives like coupons or special offers based on timing and frequency of user queries.

In some examples, when the user confirms they want to purchase a product during a conversation with a chatbot of the chatbot system, the chatbot system processes their payment method. The chatbot system confirms or pre-populates fulfillment details like shipping address. The chatbot system provides a transaction confirmation and receipt in the chat interface and notifies the vendor to initiate order handling.

Other technical features may be readily apparent to one skilled in the art from the following figures, descriptions, and claims.

### Networked Computing Environment

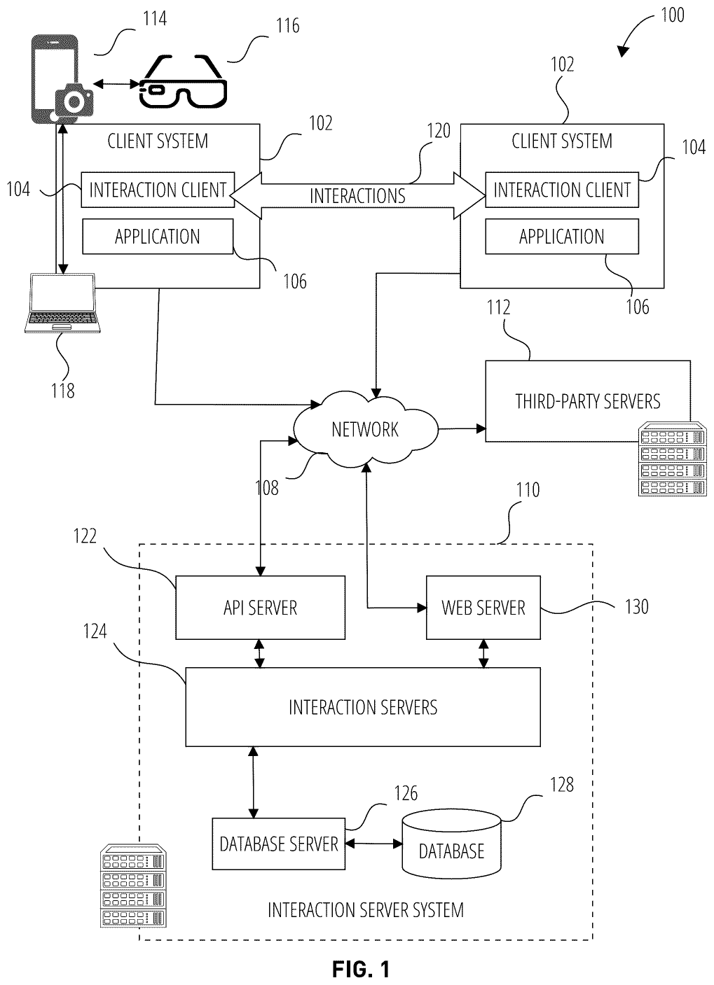

FIG. 1 is a block diagram showing an example interactive platform 100 of an interactive platform for facilitating interactions (e.g., exchanging text messages, conducting text audio and video calls, or playing games) over a network. The interactive platform 100 includes multiple client systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other client systems 102), an interaction server system 110 and third-party servers 112). An interaction client 104 can also communicate with locally hosted applications 106 using Applications Program Interfaces (APIs).

Each client system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interactive platform 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a client system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, interactive platform information, and live event information. Data exchanges within the interactive platform 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Programming Interface (API) server 122 receives and transmits interaction data (e.g., commands and message payloads) between the interaction servers 124 and the client systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a client system 102; the retrieval of messages and content; the addition and deletion of entities (e.g., friends) to an entity graph (e.g., a social graph); the location of friends within a social graph; and opening an application event (e.g., relating to the interaction client 104).

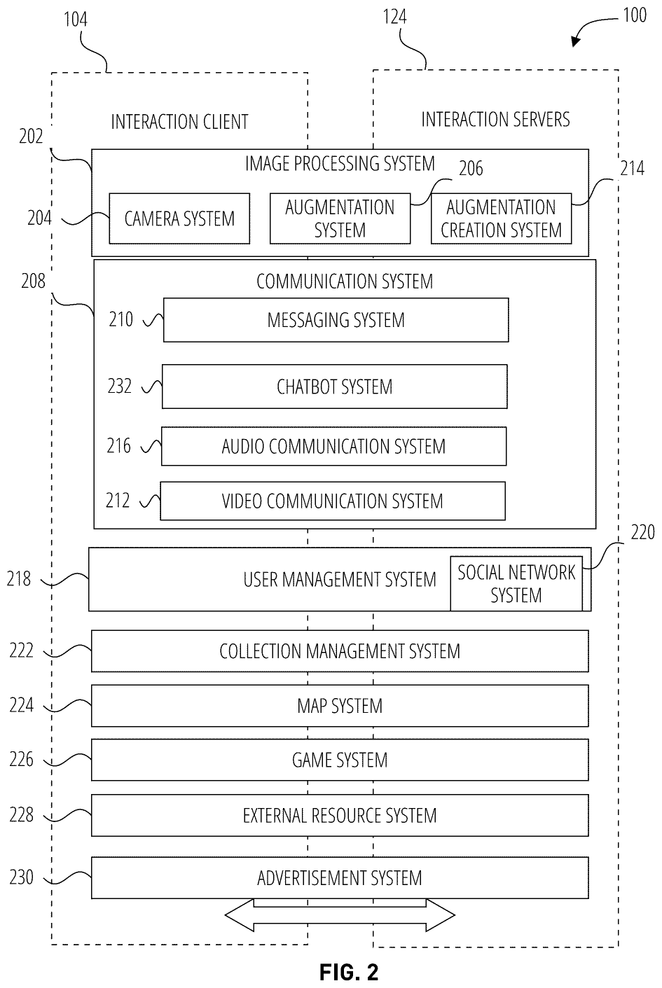

The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the client system 102 (e.g., a “native app”), or a small-scale version of the application (e.g., an “applet”) that is hosted on the client system 102 or remote of the client system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the client system 102 can be launched independently of and separately from the interaction client 104, such as by selecting an icon corresponding to the application 106 on a home screen of the client system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the client system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the client system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, using a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interactive platform 100, according to some examples. Specifically, the interactive platform 100 is shown to comprise the interaction client 104 and the interaction servers 124. The interactive platform 100 embodies multiple subsystems, which are supported on the client-side by the interaction client 104 and on the server-side by the interaction servers 124. Example subsystems are discussed below.

An image processing system 202 provides various functions that enable a user to capture and augment (e.g., augment or otherwise modify or edit) media content associated with a message.

A camera system 204 includes control software (e.g., in a camera application) that interacts with and controls hardware camera hardware (e.g., directly or via operating system controls) of the client system 102 to modify and augment real-time images captured and displayed via the interaction client 104.

The augmentation system 206 provides functions related to the generation and publishing of augmentations (e.g., media overlays) for images captured in real-time by cameras of the client system 102 or retrieved from memory of the client system 102. For example, the augmentation system 206 operatively selects, presents, and displays media overlays (e.g., an image filter or an image lens) to the interaction client 104 for the augmentation of real-time images received via the camera system 204 or stored images retrieved from memory of a client system 102. These augmentations are selected by the augmentation system 206 and presented to a user of an interaction client 104, using a number of inputs and data, such as for example:
Geolocation of the client system 102; and
interactive platform information of the user of the client system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at client system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the client system 102 or a video stream produced by the client system 102. In some examples, the media overlay may be a location overlay (e.g., Venice beach), a name of a live event, or a name of a merchant overlay (e.g., Beach Coffee House). In further examples, the image processing system 202 uses the geolocation of the client system 102 to identify a media overlay that includes the name of a merchant at the geolocation of the client system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interactive platform 100 and includes a messaging system 210, a chatbot system 232, an audio communication system 216, and a video communication system 212. The messaging system 210 is responsible for enforcing the temporary or time-limited access to content by the interaction clients 104. The messaging system 210 incorporates multiple timers within an ephemeral timer system (not shown) that, using duration and display parameters associated with a message or collection of messages (e.g., a story), selectively enable access (e.g., for presentation and display) to messages and associated content via the interaction client 104. Further details regarding the operation of the ephemeral timer system are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104. The chatbot system 232 is responsible for generating responses to prompts received from a user and communicating a response to the prompt.

A user management system 218 is operationally responsible for the management of user data and profiles, and includes an interactive platform 220 that maintains interactive platform information regarding relationships between users of the interactive platform 100.

A collection management system 222 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 222 may also be responsible for publishing an icon that provides notification of a particular collection to the user interface of the interaction client 104. The collection management system 222 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 222 employs machine vision (or image recognition technology) and content rules to curate a content collection automatically. In certain examples, compensation may be paid to a user to include user-generated content into a collection. In such cases, the collection management system 222 operates to automatically make payments to such users to use their content.

A map system 224 provides various geographic location functions and supports the presentation of map-based media content and messages by the interaction client 104. For example, the map system 224 enables the display of user icons or avatars (e.g., stored in profile data 702) on a map to indicate a current or past location of “friends” of a user, as well as media content (e.g., collections of messages including photographs and videos) generated by such friends, within the context of a map. For example, a message posted by a user to the interactive platform 100 from a specific geographic location may be displayed within the context of a map at that particular location to “friends” of a specific user on a map interface of the interaction client 104. A user can furthermore share his or her location and status information (e.g., using an appropriate status avatar) with other users of the interactive platform 100 via the interaction client 104, with this location and status information being similarly displayed within the context of a map interface of the interaction client 104 to selected users.

A game system 226 provides various gaming functions within the context of the interaction client 104. The interaction client 104 provides a game interface providing a list of available games that can be launched by a user within the context of the interaction client 104 and played with other users of the interactive platform 100. The interactive platform 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 228 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A WebViewJavaScriptBridge running on a client system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 230 operationally enables the purchasing of advertisements by third parties for presentation to end-users via the interaction clients 104 and also handles the delivery and presentation of these advertisements.

In some examples, an interactive platform provides robust infrastructure to handle huge volumes of data, customer traffic and transactions at scale.

In some examples, an interactive platform leverages technologies like Kubernetes, Docker, AWS, GCP, Azure or similar platforms for deployment.

In some examples, an interactive platform is built with a microservices architecture for scalability and flexibility.

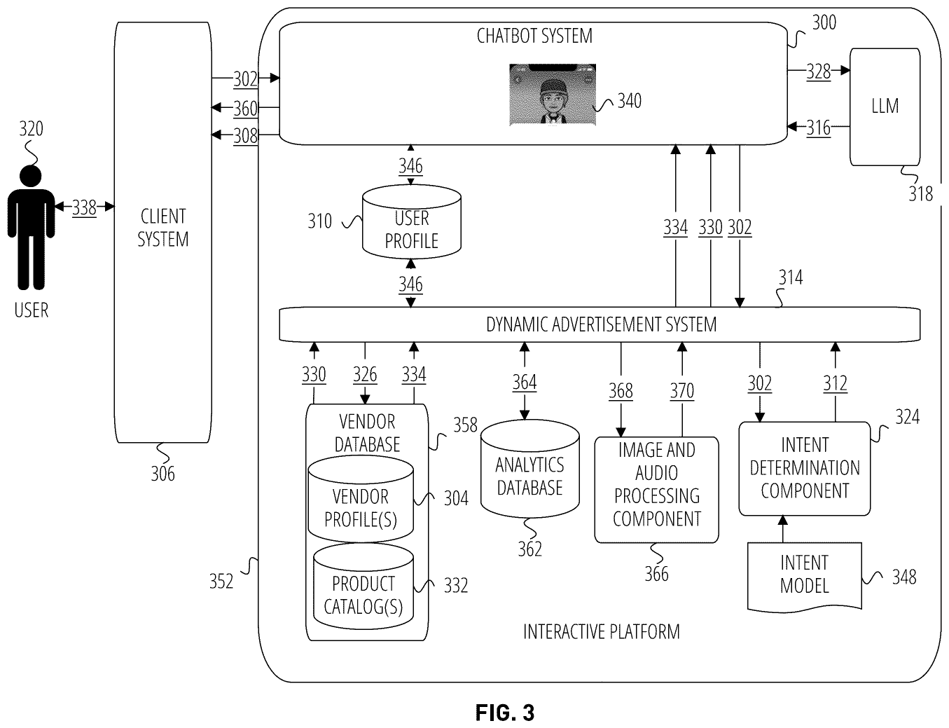

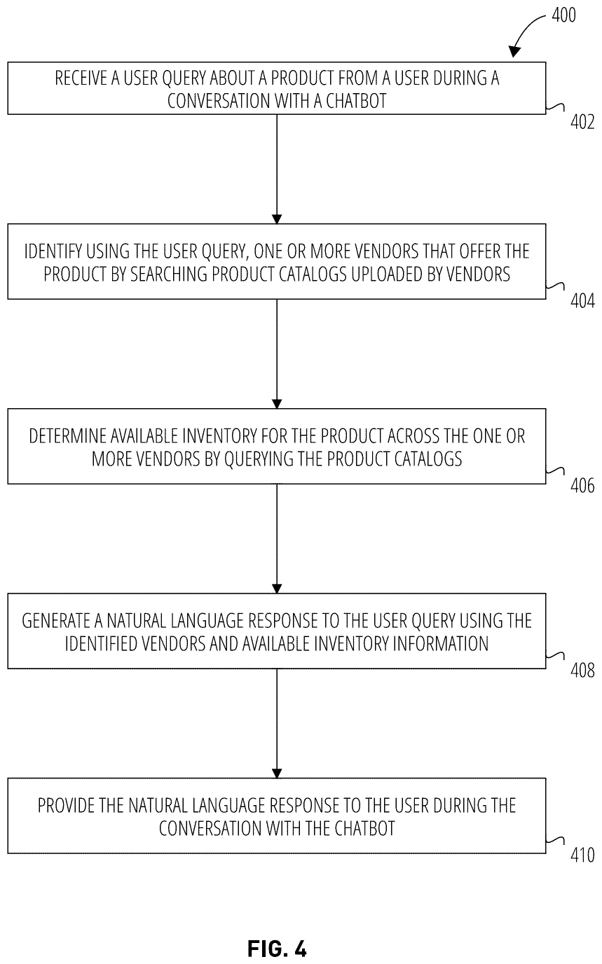

FIG. 3 is an illustration of a chatbot system of an interactive platform and FIG. 4 is a process flow diagram of a dynamic advertisement method that provides advertisements and facilitates purchase of a product during a conversation between a user and a chatbot of the chatbot system, in accordance with some examples. An interactive platform 352, such as interactive platform 100 (of FIG. 1), provides for interactions with one or more services of the interactive platform 352 using a chatbot system 300, such as chatbot system 232 (of FIG. 2). The chatbot system 300 is a component of the interactive platform 352 and utilizes a dynamic advertisement system 314, such as such as advertisement system 230 (of FIG. 2) of the interactive platform 352. Although an example dynamic advertisement method 400 depicts a particular sequence of operations, the sequence may be altered without departing from the scope of the present disclosure. For example, some of the operations depicted may be performed in parallel or in a different sequence that does not materially affect the function of the dynamic advertisement method 400. In other examples, different components of an interactive platform that implements the dynamic advertisement method 400 may perform functions at substantially the same time or in a specific sequence.

In some examples, the chatbot system 300 is a software platform designed to simulate human conversation through voice commands or text chats. The chatbot system 300 employs natural language processing (NLP) and machine learning (ML)/artificial intelligence methodologies to understand and interpret user messages 302 of the user 320 and generate chatbot messages 308 during a conversation 338.

In some examples, the chatbot system 300 receives user messages 302 from the user 320 via a client system 306 during a conversation 338 that the user 320 is having with the chatbot 340 of the chatbot system 300. The chatbot system 300 receives the user messages 302 and generates questions or prompts 328 for one or more generative models such as, but not limited to, LLM 318. The LLM 318 receives the prompts 328 and generates responses 316 using the prompts 328. The LLM 318 communicates the responses 316 to the chatbot system 300. The chatbot system 300 receives the responses 316 and generates chatbot messages 308 using the responses 316. The chatbot system 300 communicates the chatbot messages 308 to the user 320 via the client system 306 during the conversation 338.

In some examples, the user messages 302 may include other types of data as well as text data such as, but not limited to, image data, augmented reality data, video data, audio data, electronic documents, links to data stored on the Internet or the client system 306, and the like. In addition, the user messages 302 may include media such as, but not limited to, audio media, image media, video media, textual media, and the like. Regardless of the data type of the user messages 302, keyword attribution and expansion may be used to automatically generate a cluster of keywords or attributes that are associated with the received user message 302. For example, image recognition may be deployed to identify objects and location associated with visual media and image data and to generate a keyword cluster or cloud that is then associated with the image-based prompt.

The user messages 302 may furthermore be received through any number of interfaces and I/O components of a client system 306. These include gesture-based inputs obtained from a biometric component and inputs received via a Brain-Computer Interface (BCI).

In some examples, the chatbot system 300 is integrated into various platforms such as, but not limited to, websites, messaging apps, and mobile apps, allowing users to interact with the chatbot 340 through text or voice commands.

In some examples, the chatbot system 300 provides a web interface for customers to chat with businesses and make purchases on desktop. The chatbot system 300 builds the web interface using web technologies like HTML, CSS and JavaScript.

In some examples, the chatbot system 300 provides native mobile apps for iOS and Android for customers to chat, browse products and make purchases on the go.

In some examples, the chatbot system 300 provides a voice interface for customers to make hands-free purchases through smart speakers like Amazon Echo or Google Home. The chatbot system 300 builds the voice interface using voice technologies like Alexa Skills or Google Actions.

In some examples, the chatbot system 300 uses a messaging system of the interactive platform to generate the chatbot messages 308 and the catalog details 330 provided to the user 320. The chatbot system 300 generates the contents of the catalog details 330 and the chatbot messages 308 using the responses 316 and communicates the contents of the catalog details 330 and the chatbot messages 308 to the messaging system of the interactive platform. The messaging system receives the contents of the catalog details 330 and the chatbot messages 308 and generates the catalog details 330 and the chatbot messages 308 and communicates the catalog details 330 and the chatbot messages 308 to the user 320 via the client system 306.

In operation 402, the chatbot system 300 receives a user query about a product from a user in a chat interface. For example, the chatbot system 300 provides a conversational chat interface in the form of a chatbot 340 that allows the user 320 to submit natural language queries and engage in a conversation with the chatbot 340. When the user 320 inputs a query asking about a particular product, such as “Do you have this shirt in blue?” or “What are the dimensions of this refrigerator model?”, the chatbot system 300 detects and analyzes the query using natural language processing techniques. The goal is to understand the user's intent-that they are asking about a specific product and want details or availability information.

In some examples, the chatbot system implements the backend intelligence and integrations with inventory/catalog data to understand the user's product query and formulate a relevant response. Determining the product being asked about and properly scoping the user intent from their natural language input is an important first step in retrieving the correct product details and generating an accurate response. The chatbot system leverages AI and machine learning to continuously improve its ability to parse and comprehend user queries about products submitted through the conversational chat interface.

In some examples, the dynamic advertisement system 314 extracts product details 312 about the product from the user query using an intent determination component 324 that utilizes an intent model 348 and AI methodologies including Natural Language Processing (NLP) to extract product details 312 from the user messages 302. This may include identifying the product name, brand, category, attributes, or other specifics that can help better understand what product the user 320 is interested in.

The intent determination component 324 looks for semantic clues within the user query to determine the product intent even when the user doesn't explicitly provide all the details. For example, if the user messages “I'm looking for a new phone with a great camera”, the system can extract that they are interested in a smartphone with strong photography capabilities.

Extracting these product details 312 from natural language queries allows the dynamic advertisement system 314 to have a more informed understanding of the user's interests and needs. This enables providing more relevant responses, product recommendations, inventory availability, and other enhancements to the conversational experience. In some examples, more advanced NLP techniques like entity recognition, intent analysis, and sentiment analysis may also be leveraged to further improve extraction accuracy.

In some examples, the intent determination component 324 allows the chatbot 340 to have more robust conversational interactions around products even when queries are ambiguous, incomplete or include colloquial language.

In operation 404, the dynamic advertisement system 314 identifies one or more vendors that offer the product by searching one or more product catalogs product catalog 332 uploaded by vendors. For example, once the dynamic advertisement system 314 understands the product being asked about by the user 320, the dynamic advertisement system 314 generates a product query 326 and uses the product query 326 and one or more product catalogs 332 stored in a vendor database 358 to determine which vendors carry that product. To enable this determination, the interactive platform 352 maintains a database of product catalogs 332 from various vendors such as, but not limited to, online retailers, brands, distributors, and the like.

In some examples, the vendors integrate with the dynamic advertisement system 314 by uploading structured data feeds of their product catalog. The structured data includes, but is not limited to, product IDs, names, descriptions, pricing, inventory levels, images, and the like. The dynamic advertisement system 314 normalizes and indexes this catalog data in a vendor database that can be quickly and efficiently searched.

In some examples, the interactive platform 352 enables vendors to upload their product catalog data through an API or web portal in the standardized schema.

In some examples, the interactive platform 352 validates the uploaded data to ensure quality, accuracy and compliance with the schema. The chatbot system 300 rejects any invalid data.

In some examples, the interactive platform 352 ingests approved data into the product catalog database, which contains catalog data from all integrated vendors.

In some examples, the interactive platform 352 makes vendors responsible for keeping their catalog data up-to-date by uploading any changes, additions or deletions. The chatbot system 300 monitors for outdated product data.

In some examples, the interactive platform 352 transforms all the ingested catalog data into a common format and structure optimized for search and retrieval.

In some examples, the interactive platform 352 normalizes the data because vendors may organize or label their data differently. The normalization process maps all vendor data to the same schema. For example, the interactive platform 352 maps different size labels to a standard set of sizes.

In some examples, the interactive platform 352 cleans and de-dupes the data by removing invalid values, duplicates or inconsistencies as part of the normalization process.

In some examples, the normalized data is what the AI system accesses when the interactive platform 352 performs product search, recommendations and responses.

In some examples, the product catalogs 332 comprise video overviews or augmented reality (AR) demos of products within the conversational commerce experience. This multimedia product content enables more interactive and visual product exploration for customers.

To support this, the dynamic advertisement system 314 utilizes an image and audio processing component 366 to analyze and understand multimedia content 368 and generate multimedia descriptions 370. For video overviews of products, the image and audio processing component 366 uses methodologies such as, but not limited to, automated speech recognition, object detection, scene understanding, natural language processing of transcripts, and the like. This allows the dynamic advertisement system 314 to determine product details, features, and metadata from the multimedia content 368.

For AR demos, the system would need to integrate with AR engines to recognize 3D models of products, understand product interactions and simulations, and enable conversational commands to control the AR experience.

The system could extract visual details on product attributes like size, color, materials, and design from image analysis of product photos and videos.

These multimedia analysis capabilities allow the system to connect multimedia content back to product catalogs and enable relevant multimedia responses for customer queries. For example, automatically providing a video overview of a particular product model when the customer asks about it.

The system could also generate conversational responses summarizing key details extracted from multimedia for quick access without the user having to watch the full video or AR demo.

In some examples, when a product query is received from the user 320, the dynamic advertisement system 314 performs a lookup of the aggregated vendor product catalog data to find matches for the queried product. In some examples, fast lookup methodologies such as, but not limited to, fuzzy string matching, synonym mapping, and the like, are used to identify relevant products in the product catalogs 332 of the vendor database 358. The goal is to determine all the vendors that potentially carry the product inquired about by the user 320 so that availability, pricing, shipping options, and the like. can be compared across vendors.

In operation 406, the dynamic advertisement system 314 determines available inventory for the product across the one or more vendors by querying the product catalog 332. For example, after identifying the vendors that potentially carry the product, the chatbot system checks real-time inventory levels to determine actual availability and options to present to the user 320.

In some examples, the dynamic advertisement system 314 leverages the comprehensive product catalogs 332 from each integrated vendor, which contain up-to-date inventory quantities, locations, attributes, and other details at a SKU level. When the vendors upload their latest catalogs, any changes in inventory are reflected.

In some examples, to find available inventory across vendors, the chatbot system programmatically queries the product catalog databases using APIs, web services, or other integration methods. This allows it to retrieve current inventory quantities, SKU attributes, and availability information for the specific product the user 320 asked about at each vendor.

In some examples, by aggregating and checking the inventory in real-time across multiple vendor catalogs, the chatbot system 300, using the dynamic advertisement system 314 can determine and compare availability of a product across vendors. This allows the chatbot system 300 to provide the user 320 with the most relevant, accurate and up-to-date information on their product query, such as whether the product is in stock, available options and attributes, delivery timelines, and the like. Having access to live inventory data across catalogs is key to responding to natural language product queries in a conversational manner.

In some examples, the dynamic advertisement system 314 searches the product catalogs 332 based on extracted product details 312 about the product. For instance, after extracting information like the product name, brand, category, attributes, etc. from the natural language query of the user 320, the dynamic advertisement system 314 leverages these details to conduct more informed and accurate searches of the vendor product catalogs 332.

In some examples, rather than just searching for generic terms, the extracted product details 312 allow the dynamic advertisement system 314 to craft a targeted search query to the product catalogs 332. This focuses the search and improves the relevance of the catalog search results included in the catalog details 330.

In an example, if the user 320 asks about “red Nike running shoes”, the dynamic advertisement system 314 would extract “Nike” as the brand, “running shoes” as the product category, and “red” as a desired color attribute. It would then search the vendor product catalogs 332 specifically for red Nike running shoes. Without intelligent extraction of the product details 312 from the natural language user query, the dynamic advertisement system 314 may search the product catalogs 332 using incomplete or irrelevant terms. Powered by AI methodologies, the dynamic advertisement system 314 can construct a catalog search tailored to the stated product interest of the user 320.

In some examples, extracting product details from the conversational user query allows the advertisement system to execute a more precise and user-aligned search of the integrated product catalogs. This enhances the accuracy of the system's responses regarding vendor availability, inventory, and other key product details.

In operation 408, the chatbot system 300 generates a natural language response to the user query using the identified vendors and available inventory information included in the catalog details 330. For example, after the dynamic advertisement system 314 has determined which vendors carry the product and what inventory is available across them, the dynamic advertisement system 314 communicates the catalog details 330 to the chatbot system 300. The chatbot system 300 receives the chatbot system 300 and uses the catalog details 330 to generate one or more prompts 328 that are communicated to the LLM 318. The LLM 318 receives the prompts 328 and generates a response 316 using the prompts 328. The LLM 318 communicates the response 316 to the chatbot system 300 and the chatbot system 300 receives the response 316. The chatbot system 300 uses the response 316 to generate a natural language product query message 360 to provide back to the user 320 via the client system 306.

In some examples, the chatbot system 300 uses natural language generation technology to use the vendor, product, inventory, and other relevant data included in the catalog details 330 to construct a natural sounding response included in the product query message 360. This allows the chatbot system 300 to engage in a back-and-forth conversation 338 with the user 320 about the product, rather than just returning rigid pre-defined responses.

In some examples, the natural language response 316 and related product query message 360 are designed to directly address the user's initial product query and provide helpful details such as, but not limited to:
Which vendors have the product in stock.
Options for colors, sizes, styles, or other attributes.
Comparative pricing across vendors.
Estimated shipping times.
Inventory Quantities or Constraints.

In some examples, the intent determination component 324 may consider factors such as, but not limited to, the vendors'relationship with the platform, product price, availability, shipping speed, user preferences, and other data to tailor a pertinent response. For example, the intent determination component 324 may rank or compare the vendors in the response. In some examples, the dynamic advertisement system 314 ranks the one or more vendors based on one or more ranking factors that comprise: vendor relationship with a platform provider, product price, product availability, and shipping speed. For instance, when determining the order to present vendors to the user, the dynamic advertisement system 314 considers various ranking factors to ensure the most relevant vendors appear first.

In some examples, the dynamic advertisement system 314 may analyze:
Vendor relationship with the platform provider—Vendors who have invested in deeper integration or partnerships may be ranked higher.
Product price—Vendors offering the lowest prices on the product may be prioritized.
Product availability—Vendors with the product in stock and ready to ship may rank higher than those with delays.
Shipping speed—Vendors that can deliver the product fastest based on the user's location may be preferred.

By programmatically factoring in these ranking dimensions, the dynamic advertisement system 314 can optimize the vendor recommendations for relevance to each specific user and their query. Price-sensitive users may get the lowest prices shown first, while users who prioritize availability and shipping speed may get those options ranked higher.

In some examples, the platform relationships also allow preferred business partners to be promoted accordingly. Considering these ranking factors enables personalized vendor recommendations tailored to user needs and platform business objectives.

In some examples, the dynamic advertisement system 314 recommends additional products to the user 320 based on analysis of the user query and a user profile 310 stored in a data store of the interactive platform 352. The user profile 310 may be updated by various components of the interactive platform 352 including the chatbot system 300 storing user profile information 346 about conversations the chatbot 340 has with the user 320 and the dynamic advertisement system 314 storing user profile information 346 about previous product details 312 the dynamic advertisement system 314 has provided for the user 320. For instance, after responding to the user's initial product query, the dynamic advertisement system 314 can provide recommendations for complementary or related products that may also suit the need and interests of the user 320.

In some examples, to provide relevant recommendations, the dynamic advertisement system 314 analyzes:
The original user query-The intent extracted around product type, features, brand preferences, and the like informs suitable recommendations.
User profile and purchase history-Previous interactions and purchases made by the user 320 help determine their preferences to make personalized recommendations.
Trending or frequently purchased products-Recommending generally popular products can also match user interests.

In some examples, providing additional recommendations creates opportunities for upselling and expanded sales beyond just the original user query. By analyzing both their immediate query and broader profile, the dynamic advertisement system 314can suggest relevant products tailored to each individual user, enhancing the conversational commerce experience.

In some examples, the dynamic advertisement system 314 updates the user profile 310 based on details extracted from the user query. For instance, the natural language processing conducted by the intent determination component 324 to understand the user's query also provides additional insights into the interests, needs, and preferences of the user 320. These details can be used to enrich the persistent user profile 310 within the interactive platform 352.

Some examples of profile updating include, but are not limited to:
Extracting a new product category interest from the user's query and adding it to their profile. If they ask about running shoes, their profile is updated to show an interest in fitness.
Identifying a new brand preference from the query and adding it to their likes. If they ask about Samsung phones, Samsung is added as a preferred brand.
Determining a new feature interest from the query and noting it in their profile. If they ask about phone battery life, battery life is added as an interest.
Flagging a new demographic detail like age, gender or location that can help improve recommendations.

In some examples, the dynamic advertising system 314 personalizes product recommendations using their social connections and influencers. The dynamic advertising system 314 looks at what types of products a customer's friends, family and influencers are engaging with on the interactive platform 352 to provide more tailored product recommendations. For example, the dynamic advertising system 314 analyzes the product browsing, querying, and purchasing patterns of the social graph and influencer connections of the user 320 to identify relevant trends and affinity groups. The dynamic advertising system 314 then factors these additional signals to showcase products preferred by a broader social circle of the user 320, rather than just their individual history. This allows the dynamic advertising system 314 to provide a more holistic perspective of products that resonate with the needs and lifestyle of the user 320, leading to more personalized and relevant recommendations. The social context helps move beyond one-size-fits-all recommendations to suggestions tailored to each user's unique social identity and spheres of influence.

In some examples, the user profile 310 enables the dynamic advertisement system 314 to serve the user 320 better recommendations, search results, and other personalized experiences. The details extracted from ongoing natural language user queries during a conversation provide an additional source of profile enrichment beyond just past purchases and clicks. This allows the user profile to incrementally improve over time, becoming more reflective of the user's current interests and responsive to their changing needs. Their experience on the platform becomes more tailored as additional natural language interactions are captured.

In some examples, the dynamic advertisement system 314 expands the types of products and services that can be queried, beyond just physical products. The user 320 may ask the chatbot 340 about local service providers, restaurants, entertainment options and more. The dynamic advertisement system 314 integrates various verticals into a central query and recommendation engine. For instance, the dynamic advertisement system 314 indexes and catalogs local businesses like contractors, doctors, lawyers, repair shops, restaurants, venues, activities and other services. Customers can query this expanded catalog of offerings in natural language, and the dynamic advertisement system 314 understands the intent and provides relevant recommendations. The dynamic advertisement system 314 draws connections between different types of businesses to enable queries that span categories and verticals. For example, a user could ask for family-friendly restaurant options nearby a recommended movie theater showing a new kids'film. By expanding the range of products and services covered, the dynamic advertising system 314 becomes a comprehensive destination for conversational commerce across local lifestyle needs.

In some examples, the chatbot system 300 suggests potential queries or responses as the user 320 is typing to help guide the conversation and provide more efficient interactions. As the user 320 enters their message in the chat interface, the chatbot system 300 leverages predictive text and language models to generate relevant smart reply suggestions or fully composed suggestions. These suggestions appear dynamically as the user is drafting their message, allowing the user 320 to simply tap a suggestion to send it instead of typing the full message. In some examples, the chatbot system 300 draws on context from a conversation history and user profile 310 to predictively provide the most relevant suggestions personalized for each user. By proactively recommending potential queries or responses, the chatbot system 300 helps the user 320 compose messages faster and guides the conversation in more productive directions. The real-time suggestions enhance the interactivity of the conversational experience.

In some examples, generating conversational responses leveraging AI methodologies to synthesize complex product/vendor/inventory data into natural language allows for providing an intuitive self-service experience via a conversation 338 with a chatbot 340.

In some examples, the chatbot 340 mimics a human sales agent with product expertise tailored specifically to the user's query.

In operation 410, the chatbot system 300 provides the natural language product query message 360 to the user during the conversation 338. For example, after formulating the natural language product query message 360 comprising relevant vendor, product, and inventory information, the chatbot system 300 provides this information to the user 320 through a conversational chat interface via the client system 306 during the conversation 338.

In some examples, the chatbot system 300 integrates backend product search, vendor matching, inventory checking, and natural language generation with the front-end chat interface to maintain a continuous conversation 338 with the user 320.

In some examples, the natural language product query message 360 is delivered through the same interactive platform (e.g., website, mobile app, and the like) that the user 320 originally submitted their query through. This allows the conversation 338 to remain within the same chat thread, rather than redirecting the user 320 elsewhere.

In some examples, from a perspective of the user 320, it appears as if the use user 320 is chatting with an entity that has extensive product knowledge and can provide detailed availability information on the product the user 320 asked about. The chatbot system 300 handles fetching the relevant data and presenting the relevant data conversationally.

In some examples, the chatbot system 300 completes a product purchase transaction within the chat interface based on confirmation from the user 320. As an example, after helping the user find the product they are looking for and confirming availability, pricing, shipping, and the like, the chatbot system 300 facilitates completing the actual purchase directly within the conversational chat flow of the conversation 338.

In some examples, completing the product purchase comprises:
Summarizing the order details like items, quantities, shipping address, and total price for the user to confirm.
Integrating payment processing so the user can securely provide payment details like credit card or digital wallet information.
Capturing any additional information required to finalize the transaction, like contact info for delivery.
Explicitly asking the user to confirm their desire to make the purchase.
Processing the payment and order fulfillment through ecommerce APIs integrated into the interactive platform 352.
Providing the user confirmation of the completed order and any tracking details for delivery monitoring.

By handling the entire purchase end-to-end within the conversational interface, the chatbot system 300 provides a streamlined commerce experience for the user 320 without forcing the user 320 to switch contexts across different sites or applications. Purchases triggered from within the conversation 338 can be fully transacted with user confirmation, improving convenience and platform stickiness.

In some examples, the dynamic advertisement system 314 utilizes vendor personalities using vendor chatbot customizations 334 included in vendor profiles 304 stored in the vendor database 358 to determine a vendor personality. For instance, each vendor or merchant on the platform can configure a vendor profile that specifies preferences for the personality exhibited by the chatbot 340 when interacting with customers.

In some examples, the vendor profile setting controls include, but are not limited to:
Personality type—e.g. professional, casual, humorous, or a predefined personality template.
Tone—The emotional tone used in responses, such as excited, matter-of-fact, enthusiastic, etc.
Word choice—The vocabulary and phrasing used, like formal vs informal language.
Emojis and visual elements—The visual components that complement the text responses.
Voice—Accent, pitch, speed if voice interactions are used.
Background—Avatars, images, or other visual branding.

In some examples, when engaging in a conversational session with a customer, the dynamic advertisement system 314 references a respective vendor profile of the vendor profiles 304 to dynamically adjust an interaction to match the vendor personality. This allows each vendor to craft a unique brand personality tailored to their target demographic and brand image. In some examples, the dynamic advertisement system 314 provides the same underlying functionality while exhibiting different personalities. This helps personify each vendor and provides a more engaging customer experience through the conversation 338.

In some examples, the dynamic advertisement system 314 stores user queries and conversation data 364 in a 362. This provides an analytics platform to gain valuable insights from customer product queries and conversations. This analytics platform can help businesses in several ways. In some examples, the analytical platform analyzes aggregate trends and patterns in the types of products customers are asking about, their features of interest, the information they seek, and pain points expressed. These insights identify rising product interests, changing needs, issues with existing products, market gaps for new products, and more. Businesses can use these analytics to refine product design and development, adjust marketing content and campaigns, promote the most in-demand products, and better align offerings with consumer needs.

In some examples, the analytical platform provides an improve post-purchase customer experience by tracking how customers interact with products after purchase in their queries and conversations (e.g., set-up issues, use cases, defects, enhancements sought, and the like). This provides feedback on real-world product usage, customer satisfaction, and needs for improvements in design, user experience, documentation, or support. Businesses can continuously improve products, support channels, self-help content and other post-purchase experiences based on these customer insights.

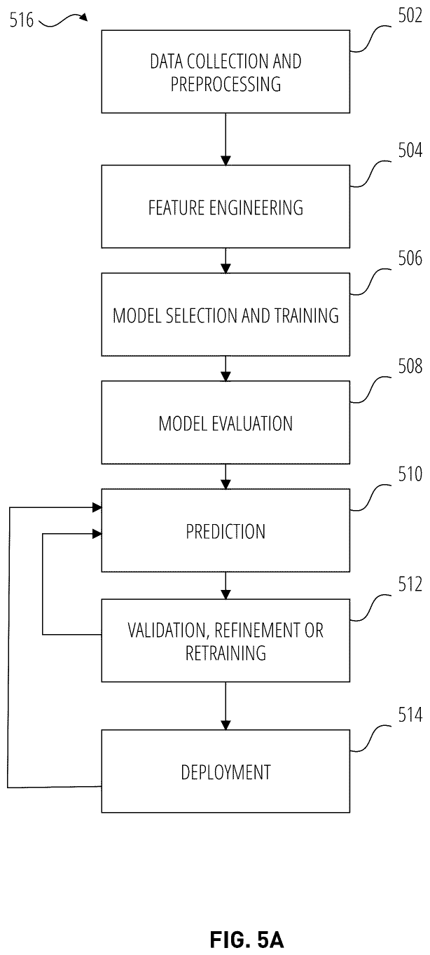

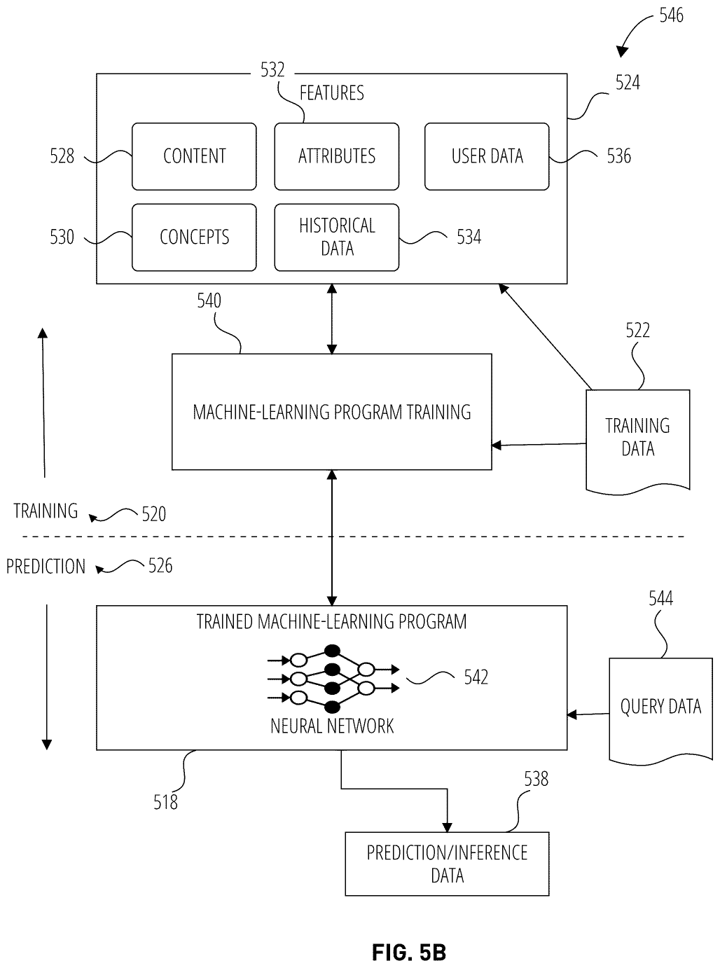

FIG. 5A is a process flow diagram depicting a machine learning and deployment process 516 and FIG. 5B is an illustration of a machine learning and deployment pipeline 546, according to some examples. The machine learning and deployment pipeline 546 may be used to generate a trained machine-learning program 518 such as, but not limited to, an intent model 348 (of FIG. 3), to perform operations associated with searches and query responses of the dynamic advertisement system 314 (of FIG. 3).

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable using one or more predictor variables. Another example type of machine learning algorithm is Naïve Bayes, which is another supervised learning algorithm used for classification tasks. Naïve Bayes is based on Bayes'theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions using the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine-learning program 518 may include multiple phases that form part of the machine learning and deployment pipeline 546, including for example the following phases illustrated in FIG. 5A:
Data collection and preprocessing 502: This phase may include acquiring and cleaning data to ensure that it is suitable for use in the machine learning model. This phase may also include removing duplicates, handling missing values, and converting data into a suitable format.
Feature engineering 504: This phase may include selecting and transforming the training data 522 to create features that are useful for predicting the target variable. Feature engineering may include (1) receiving features 524 (e.g., as structured or labeled data in supervised learning) and/or (2) identifying features 524 (e.g., unstructured or unlabeled data for unsupervised learning) in training data 522.
Model selection and training 506: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 508: This phase may include evaluating the performance of a trained model (e.g., the trained machine-learning program 518) on a separate testing dataset. This phase can help determine if the model is overfitting or underfitting and determine whether the model is suitable for deployment.
Prediction 510: This phase involves using a trained model (e.g., trained machine-learning program 518) to generate predictions on new, unseen data.
Validation, refinement or retraining 512: This phase may include updating a model using feedback generated from the prediction phase, such as new data or user feedback.
Deployment 514: This phase may include integrating the trained model (e.g., the trained machine-learning program 518) into a more extensive system or application, such as a web service, mobile app, or IoT device. This phase can involve setting up APIs, building a user interface, and ensuring that the model is scalable and can handle large volumes of data.

FIG. 5B illustrates further details of two example phases, namely a training phase 520 (e.g., part of the model selection and trainings 506) and a prediction phase 526 (part of prediction 510). Prior to the training phase 520, feature engineering 504 is used to identify features 524. This may include identifying informative, discriminating, and independent features for effectively operating the trained machine-learning program 518 in pattern recognition, classification, and regression. In some examples, the training data 522 includes labeled data, known for pre-identified features 524 and one or more outcomes. Each of the features 524 may be a variable or attribute, such as an individual measurable property of a process, article, system, or phenomenon represented by a data set (e.g., the training data 522). Features 524 may also be of different types, such as numeric features, strings, and graphs, and may include one or more of content 528, concepts 530, attributes 532, historical data 534, and/or user data 536, merely for example.

In training phase 520, the machine learning and deployment pipeline 546 uses the training data 522 to find correlations among the features 524 that affect a predicted outcome or prediction/inference data 538.

With the training data 522 and the identified features 524, the trained machine-learning program 518 is trained during the training phase 520 during machine-learning program training 540. The machine-learning program training 540 appraises values of the features 524 as they correlate to the training data 522. The result of the training is the trained machine-learning program 518 (e.g., a trained or learned model).

Further, the training phase 520 may involve machine learning, in which the training data 522 is structured (e.g., labeled during preprocessing operations). The trained machine-learning program 518 implements a neural network 542 capable of performing, for example, classification and clustering operations. In other examples, the training phase 520 may involve deep learning, in which the training data 522 is unstructured, and the trained machine-learning program 518 implements a deep neural network 542 that can perform both feature extraction and classification/clustering operations.

In some examples, a neural network 542 may be generated during the training phase 520, and implemented within the trained machine-learning program 518. The neural network 542 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 542 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 542 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 520, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 526, the trained machine-learning program 518 uses the features 524 for analyzing query data 544 to generate inferences, outcomes, or predictions, as examples of a prediction/inference data 538. For example, during prediction phase 526, the trained machine-learning program 518 generates an output. Query data 544 is provided as an input to the trained machine-learning program 518, and the trained machine-learning program 518 generates the prediction/inference data 538 as output, responsive to receipt of the query data 544.

In some examples, the trained machine-learning program 518 may be a generative AI model. Generative AI is a term that may refer to any type of artificial intelligence that can create new content from training data 522. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data using these relationships. Transformer models can handle sequential data, such as text or speech, as well as non-sequential data, such as images or code.

In generative AI examples, the output prediction/inference data 538 include predictions, translations, summaries or media content.

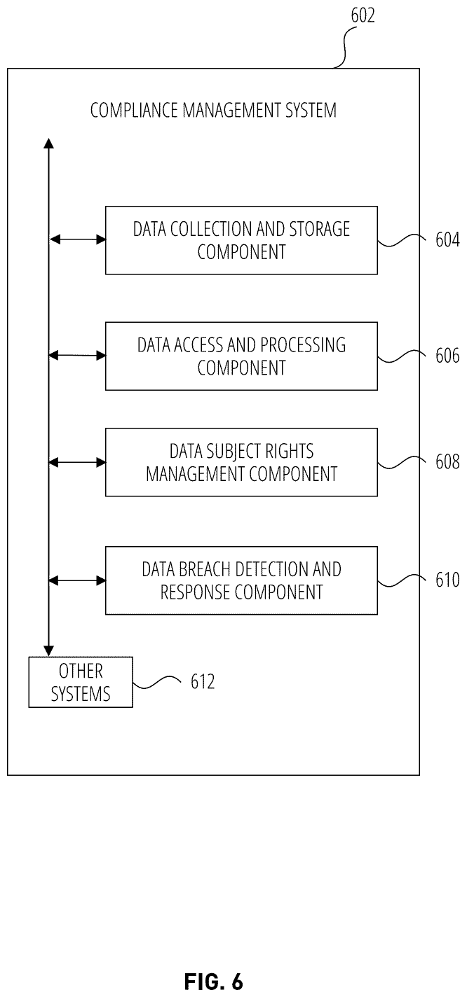

FIG. 6 is a block diagram illustrating an automated compliance management system 602, according to some examples, which may be deployed as part of an interactive platform hosting a chatbot system 300 (both of FIG. 3) to facilitate compliance with various data privacy and other legislative requirements, such as those of the General Data Protection Regulation (GDPR), Digital Services Act (DSA), California Consumer Privacy Act (CCPA), and other global privacy requirements. The compliance management system 602 operates with other systems 612 of a platform to implement user privacy and data protections and provide an environment in which an online platform can safely and responsibly operate.

Components of the compliance management system 602 may include:
A data collection and storage component 604 is responsible for securely handling user data in a way that is compliant with GDPR, DSA, CCPA, and other privacy requirements. The data collection and storage component 604 includes the following sub-components:
   Data Input Validation: This sub-component validates user input, ensuring that only necessary data is collected and stored. It uses algorithms to filter out any unnecessary information. The input validation sub-component can be designed to prevent the storage of personal information (e.g., biometric information) without explicit notification and consent from the user. To achieve this, the input validation sub-component can incorporate additional functionality including:
      Consent Detection: Before collecting and processing biometric data, the input validation sub-component may check if explicit consent has been obtained from the user. This can be done by verifying the user's consent status in a compliance management system 602, or by checking for the presence of consent-related metadata associated with the biometric data.
      Consent-Based Filtering: The input validation sub-component may allow biometric data to be stored only if the required consent has been obtained. If consent is absent, the sub-component filters out the biometric data and prevents it from being stored. This ensures that a platform only processes biometric data when appropriate consent has been given.
      Notification and Consent Management: The input validation sub-component works with a consent (e.g., opt-in/opt-out) management system that handles user notifications and manages consent records. This system may notify users about the collection and use of biometric data, provide them with the option to give or withdraw their consent, and maintain a record of the users'consent status.
Opt-in/Opt-out Management: This sub-component handles user preferences and consents for data collection and processing. It provides users with mechanisms for opting in or out of specific data processing activities, in accordance with privacy regulations.
Secure Data Storage: This sub-component stores user data using encryption, ensuring that it is protected from unauthorized access. It may use a combination of symmetric and asymmetric encryption algorithms (e.g., Advanced Encryption Standard (AES) and Rivest-Shamir-Adleman (RSA)) for maximum security.
Data Retention Policy: This sub-component enforces a data retention policy, which specifies the duration for which user data is retained. After the specified duration, data is automatically deleted using secure deletion algorithms.
Data Minimization: This sub-component ensures that a minimum amount of data necessary for specific purposes is collected and stored. It adheres to the data minimization principle in various privacy regulations, reducing the risk of unauthorized access or misuse of excessive user data. This sub-component ensures that biometric data collection is limited to what is strictly necessary for the intended purpose, in compliance with privacy regulations.
Data Categorization and Classification: This sub-component categorizes and classifies user data using its sensitivity and the level of protection required. By assigning different levels of security to various data types, it helps ensure that sensitive data receives an appropriate level of protection. This sub-component also recognizes biometric data as a sensitive category of personal data and ensures that it is treated with the appropriate level of protection.
Data Inventory Management: This sub-component maintains an up-to-date inventory of all user data collected and stored, including information about the data's purpose, location, and retention period. It enables management and tracking of user data, simplifying compliance with privacy requirements.
Privacy Impact Assessment (PIA): This sub-component evaluates the potential privacy risks associated with new data collection and storage processes or technologies. By identifying and mitigating potential risks before implementing changes, it helps maintain compliance with privacy requirements and protect user data.
Data Transfer Management: This sub-component manages and secures data transfers between different systems, services, or third parties. It ensures that data transfers are compliant with privacy requirements and that data is protected during transit using encryption and other security measures.
A data access and processing component 606 is responsible for providing controlled access to user data and ensuring that data is processed in a compliant manner. The data access and processing component 606 may include the following sub-components:
   Access Control: This sub-component manages user data access, granting access only to authorized users and services. It may use role-based access control (RBAC) to assign permissions using user roles and responsibilities.
   Data Processing Management: This sub-component ensures that data processing is compliant with GDPR, DSA, CCPA, and other privacy regulations. It uses algorithms to automatically anonymize or pseudonymize user data when required, takes into account user opt-in/opt-out preferences, and logs data processing activities for auditing purposes. This sub-component also ensures that biometric data processing complies with specific requirements and restrictions set forth by GDPR, CCPA, and other privacy regulations. This may include obtaining explicit consent from the individual, processing for specific purposes, or anonymizing and pseudonymizing biometric data when required.
A data subject rights management component 608 is responsible for managing and facilitating user rights requests as per GDPR, DSA, CCPA, and other privacy regulations. The data subject rights management component 608 may include the following sub-components:
   User Rights Request Processing: This sub-component processes user rights requests, such as data access, rectification, erasure, data portability, and opt-out requests. It uses algorithms to automatically validate and execute these requests, ensuring compliance and timely responses.
   User Rights Request Logging: This sub-component logs all user rights requests and their outcomes, creating an audit trail that can be reviewed for compliance purposes.
A data breach detection and response component 610 is responsible for detecting and responding to data breaches in a timely and compliant manner. The data breach detection and response component 610 may include the following sub-components:
   Data Breach Detection: This sub-component uses machine learning algorithms to continuously monitor and analyze the system for any signs of data breaches or unauthorized access.
   Data Breach Response: This sub-component initiates predefined incident response procedures in case of a detected data breach. It ensures that the breach is contained, assessed, and reported to the relevant authorities as required by GDPR, DSA, CCPA, and other privacy regulations.

The compliance management system 602 is designed to provide a comprehensive solution for social media platforms to comply with GDPR, DSA, CCPA, and other privacy requirements. By implementing secure data collection and storage, controlled data access and processing, user rights management, and data breach detection and response components, the system ensures user privacy and data protection while enabling responsible platform operation. The inclusion of opt-in/opt-out management, along with other privacy controls, further empowers users to manage their data preferences and helps the platform maintain compliance with evolving privacy regulations.

### Data Architecture

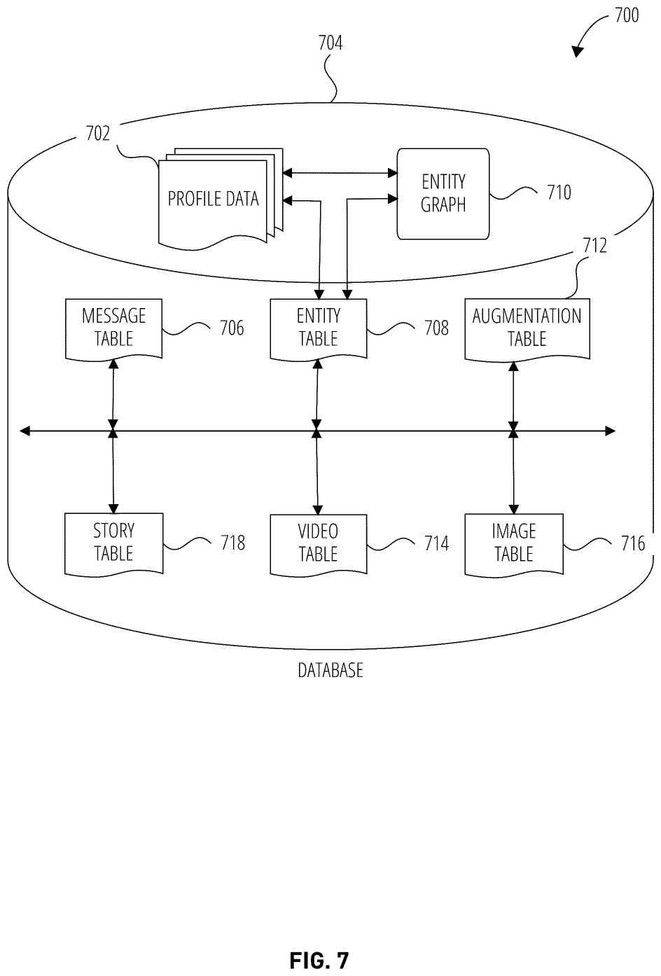

FIG. 7 is a schematic diagram illustrating data structures 700, which may be stored in the database 704 of the interaction server system 110, according to certain examples. While the content of the database 704 is shown to comprise multiple tables, it will be appreciated that the data could be stored in other types of data structures (e.g., as an object-oriented database).

The database 704 includes message data stored within a message table 706. This message data includes, for any particular message, at least message sender data, message recipient (or receiver) data, and a payload. Further details regarding information that may be included in a message, and included within the message data stored in the message table 706, are described below with reference to FIG. 7.

An entity table 708 stores entity data, and is linked (e.g., referentially) to an entity graph 710 and profile data 702. Entities for which records are maintained within the entity table 708 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 710 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interactive platform 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 708. Such privacy settings may be applied to all types of relationships within the context of the interactive platform 100, or may selectively be applied to only certain types of relationships.

The profile data 702 stores multiple types of profile data about a particular entity. The profile data 702 may be selectively used and presented to other users of the interactive platform 100 based on privacy settings specified by a particular entity. Where the entity is an individual, the profile data 702 includes, for example, a username, telephone number, address, settings (e.g., notification and privacy settings), as well as a user-selected avatar representation (or collection of such avatar representations). A particular user may then selectively include one or more of these avatar representations within the content of messages communicated via the interactive platform 100, and on map interfaces displayed by interaction clients 104 to other users. The collection of avatar representations may include “status avatars,” which present a graphical representation of a status or activity that the user may select to communicate at a particular time.

Where the entity is a group, the profile data 702 for the group may similarly include one or more avatar representations associated with the group, in addition to the group name, members, and various settings (e.g., notifications) for the relevant group.

The database 704 also stores augmentation data, such as overlays or filters, in an augmentation table 712. The augmentation data is associated with and applied to videos (for which data is stored in a video table 714) and images (for which data is stored in an image table 716).

Filters, in some examples, are overlays that are displayed as overlaid on an image or video during presentation to a message receiver. Filters may be of various types, including user-selected filters from a set of filters presented to a message sender by the interaction client 104 when the message sender is composing a message. Other types of filters include geolocation filters (also known as geo-filters), which may be presented to a message sender based on geographic location. For example, geolocation filters specific to a neighborhood or special location may be presented within a user interface by the interaction client 104, based on geolocation information determined by a Global Positioning System (GPS) unit of the client system 102.

Another type of filter is a data filter, which may be selectively presented to a message sender by the interaction client 104 based on other inputs or information gathered by the client system 102 during the message creation process. Examples of data filters include current temperature at a specific location, a current speed at which a message sender is traveling, battery life for a client system 102, or the current time.

Other augmentation data that may be stored within the image table 716 includes augmented reality content items (e.g., corresponding to applying Lenses or augmented reality experiences). An augmented reality content item may be a real-time special effect and sound that may be added to an image or a video.

As described above, augmentation data includes augmented reality (AR), virtual reality (VR) and mixed reality (MR) content items, overlays, image transformations, images, and modifications that may be applied to image data (e.g., videos or images). This includes real-time modifications, which modify an image as it is captured using device sensors (e.g., one or multiple cameras) of the client system 102 and then displayed on a screen of the client system 102 with the modifications. This also includes modifications to stored content, such as video clips in a collection or group that may be modified. For example, in a client system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a client system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects, and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of an object's elements, characteristic points for each element of an object are calculated (e.g., using an Active Shape Model (ASM) or other known methods). Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification, properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

A transformation system can capture an image or video stream on a client device (e.g., the client system 102) and perform complex image manipulations locally on the client system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the client system 102.

In some examples, a computer animation model to transform image data can be used by a system where a user may capture an image or video stream of the user (e.g., a selfie) using the client system 102 having a neural network operating as part of an interaction client 104 operating on the client system 102. The transformation system operating within the interaction client 104 determines the presence of a face within the image or video stream and provides modification icons associated with a computer animation model to transform image data, or the computer animation model can be present as associated with an interface described herein. The modification icons include changes that are the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the client system 102 as soon as the image or video stream is captured and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browsing to other areas of the imaging application. Where multiple faces are modified by the transformation system, the user may toggle the modification on or off globally by tapping or selecting a single face modified and displayed within a graphical user interface. In some examples, individual faces, among a group of multiple faces, may be individually modified, or such modifications may be individually toggled by tapping or selecting the individual face or a series of individual faces displayed within the graphical user interface.

A story table 718 stores data regarding collections of messages and associated image, video, or audio data, which are compiled into a collection (e.g., a story or a gallery). The creation of a particular collection may be initiated by a particular user (e.g., each user for which a record is maintained in the entity table 708). A user may create a “personal story” in the form of a collection of content that has been created and sent/broadcast by that user. To this end, the user interface of the interaction client 104 may include an icon that is user-selectable to enable a message sender to add specific content to his or her personal story.

A collection may also constitute a “live story,” which is a collection of content from multiple users that is created manually, automatically, or using a combination of manual and automatic methodologies. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose client system 102 is located within a specific geographic location (e.g., on a college or university campus) to contribute to a particular collection. In some examples, a contribution to a location story may require a second degree of authentication to verify that the end-user belongs to a specific organization or other entity (e.g., is a student on the university campus).

As mentioned above, the video table 714 stores video data that, in some examples, is associated with messages for which records are maintained within the message table 706. Similarly, the image table 716 stores image data associated with messages for which message data is stored in the entity table 708. The entity table 708 may associate various augmentations from the augmentation table 712 with various images and videos stored in the image table 716 and the video table 714.

The databases 704 also include social network information collected by an interactive platform of an interaction system. The social network information may include without limitation relationship and communication data for users of the interactive platform. The social network information can be used to group two or more users and offer additional functionality of the interactive platform 100. Examples of relationships include, but are not limited to, best friends relationships where two or more users are determined to be mutual best friends based on a frequency of their interactions, users who have common interests in current events, users who share an affiliation through social clubs or philanthropic organizations, and the like. Examples of communications include without limitation chats, private and public messages, exchanges of media such as images, videos, audio recordings, and the like.

### Data Communications Architecture

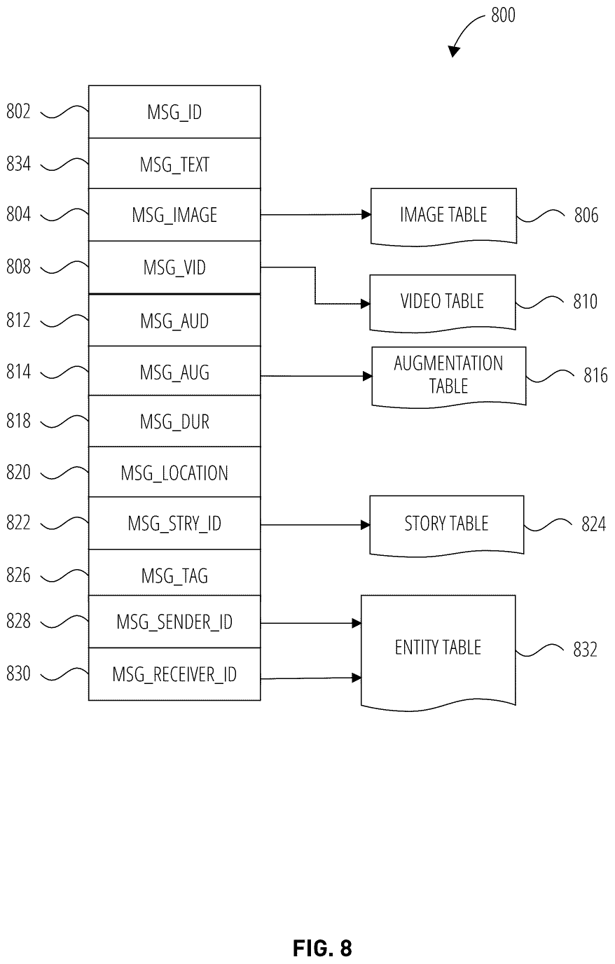

FIG. 8 is a schematic diagram illustrating a structure of a message 800, according to some examples, generated by an interaction client 104 for communication to a further interaction client 104 via the interaction servers 124. The content of a particular message 800 is used to populate the message table 706 stored within the database 704, accessible by the interaction servers 124. Similarly, the content of a message 800 is stored in memory as “in-transit” or “in-flight” data of the client system 102 or the interaction servers 124. A message 800 is shown to include the following example components:
Message identifier 802: a unique identifier that identifies the message 800.
Message text payload 834: text, to be generated by a user via a user interface of the client system 102, and that is included in the message 800.
Message image payload 804: image data, captured by a camera component of a client system 102 or retrieved from a memory component of a client system 102, and that is included in the message 800. Image data for a sent or received message 800 may be stored in the image table 806.
Message video payload 808: video data, captured by a camera component or retrieved from a memory component of the client system 102, and that is included in the message 800. Video data for a sent or received message 800 may be stored in the video table 810.
Message audio payload 812: audio data, captured by a microphone or retrieved from a memory component of the client system 102, and that is included in the message 800.
Message augmentation data 814: augmentation data (e.g., filters, stickers, or other annotations or enhancements) that represents augmentations to be applied to message image payload 804, message video payload 808, or message audio payload 812 of the message 800. Augmentation data for a sent or received message 800 may be stored in the augmentation table 816.
Message duration parameter 818: parameter value indicating, in seconds, the amount of time for which content of the message (e.g., the message image payload 804, message video payload 808, message audio payload 812) is to be presented or made accessible to a user via the interaction client 104.
Message geolocation parameter 820: geolocation data (e.g., latitudinal and longitudinal coordinates) associated with the content payload of the message. Multiple message geolocation parameter 820 values may be included in the payload, each of these parameter values being associated with respect to content items included in the content (e.g., a specific image within the message image payload 804, or a specific video in the message video payload 808).
Message story identifier 822: identifier values identifying one or more content collections (e.g., “stories” identified in the story table 824) with which a particular content item in the message image payload 804 of the message 800 is associated. For example, multiple images within the message image payload 804 may each be associated with multiple content collections using identifier values.
Message tag 826: each message 800 may be tagged with multiple tags, each of which is indicative of the subject matter of content included in the message payload. For example, where a particular image included in the message image payload 804 depicts an animal (e.g., a lion), a tag value may be included within the message tag 826 that is indicative of the relevant animal. Tag values may be generated manually, based on user input, or may be automatically generated using, for example, image recognition.
Message sender identifier 828: an identifier (e.g., a messaging system identifier, email address, or device identifier) indicative of a user of the client system 102 on which the message 800 was generated and from which the message 800 was sent.
Message receiver identifier 830: an identifier (e.g., a messaging system identifier, email address, or device identifier) indicative of a user of the client system 102 to which the message 800 is addressed.

The contents (e.g., values) of the various components of message 800 may be pointers to locations in tables within which content data values are stored. For example, an image value in the message image payload 804 may be a pointer to (or address of) a location within an image table 806. Similarly, values within the message video payload 808 may point to data stored within a video table 810, values stored within the message augmentation data 814 may point to data stored in an augmentation table 816, values stored within the message story identifier 822 may point to data stored in a story table 824, and values stored within the message sender identifier 828 and the message receiver identifier 830 may point to user records stored within an entity table 832.

### Machine Architecture

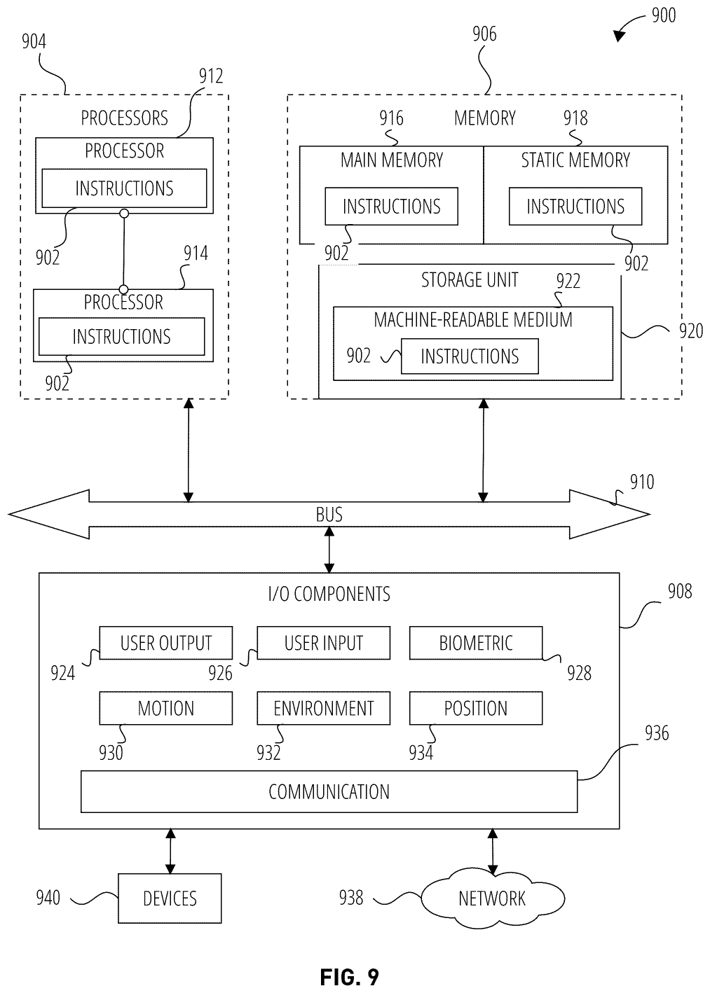

FIG. 9 is a diagrammatic representation of the machine 900 within which instructions 902 (e.g., software, a program, an application, an applet, an app, or other executable code) for causing the machine 900 to perform any one or more of the methodologies discussed herein may be executed. For example, the instructions 902 may cause the machine 900 to execute any one or more of the methods described herein. The instructions 902 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a computing apparatus, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 902, sequentially or otherwise, that specify actions to be taken by the machine 900. Further, while a single machine 900 is illustrated, the term “machine” shall also be taken to include a collection of machines that individually or jointly execute the instructions 902 to perform any one or more of the methodologies discussed herein. The machine 900, for example, may comprise the client system 102 or any one of multiple server devices forming part of the interaction server system 110. In some examples, the machine 900 may also comprise both client and server systems, with certain operations of a particular method or algorithm being performed on the server-side and with certain operations of the particular method or algorithm being performed on the client-side.

The machine 900 may include processors 904, memory 906, and input/output I/O components 908, which may be configured to communicate with each other via a bus 910. In an example, the processors 904 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 912 and a processor 914 that execute the instructions 902. The term “processor” is intended to include multi-core processors that may comprise two or more independent processors (sometimes referred to as “cores”) that may execute instructions contemporaneously. Although FIG. 9 shows multiple processors 904, the machine 900 may include a single processor with a single-core, a single processor with multiple cores (e.g., a multi-core processor), multiple processors with a single core, multiple processors with multiples cores, or any combination thereof.

The memory 906 includes a main memory 916, a static memory 918, and a storage unit 920, both accessible to the processors 904 via the bus 910. The main memory 906, the static memory 918, and storage unit 920 store the instructions 902 embodying any one or more of the methodologies or functions described herein. The instructions 902 may also reside, completely or partially, within the main memory 916, within the static memory 918, within machine-readable medium 922 within the storage unit 920, within at least one of the processors 904 (e.g., within the processor's cache memory), or any suitable combination thereof, during execution thereof by the machine 900.

The I/O components 908 may include a wide variety of components to receive input, provide output, produce output, transmit information, exchange information, capture measurements, and so on. The specific I/O components 908 that are included in a particular machine will depend on the type of machine. For example, portable machines such as mobile phones may include a touch input device or other such input mechanisms, while a headless server machine will likely not include such a touch input device. It will be appreciated that the I/O components 908 may include many other components that are not shown in FIG. 9. In various examples, the I/O components 908 may include user output components 924 and user input components 926. The user output components 924 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 926 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 908 may include biometric components 928, motion components 930, environmental components 932, or position components 934, among a wide array of other components. For example, the biometric components 928 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 930 include acceleration sensor components (e.g., accelerometer), gravitation sensor components, rotation sensor components (e.g., gyroscope). The biometric components may include a brain-machine interface (BMI) system that allows communication between the brain and an external device or machine. This is achieved by recording brain activity, translating it into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which involve surgically implanting electrodes directly into the brain.
Optogenetics BMIs, which use light to control the activity of specific nerve cells in the brain.
Functional magnetic resonance imaging (fMRI)-based BMIs, which use magnetic fields to measure blood flow in the brain, which can be used to infer brain activity.

The environmental components 932 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client system 102 may have a camera system comprising, for example, front cameras on a front surface of the client system 102 and rear cameras on a rear surface of the client system 102. The front cameras may, for example, be used to capture still images and video of a user of the client system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client system 102 may also include a 360° camera for capturing 360° photographs and videos.

Further, the camera system of the client system 102 may include dual rear cameras (e.g., a primary camera as well as a depth-sensing camera), or even triple, quad or penta rear camera configurations on the front and rear sides of the client system 102. These multiple cameras systems may include a wide camera, an ultra-wide camera, a telephoto camera, a macro camera, and a depth sensor, for example.

The position components 934 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 908 further include communication components 936 operable to couple the machine 900 to a network 938 or devices 940 via respective coupling or connections. For example, the communication components 936 may include a network interface component or another suitable device to interface with the network 938. In further examples, the communication components 936 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 940 may be another machine or any of a wide variety of peripheral devices (e.g., a peripheral device coupled via a USB).

Moreover, the communication components 936 may detect identifiers or include components operable to detect identifiers. For example, the communication components 936 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 936, such as location via Internet Protocol (IP) geolocation, location via Wi-Fi® signal triangulation, location via detecting an NFC beacon signal that may indicate a particular location, and so forth.

The various memories (e.g., main memory 916, static memory 918, and memory of the processors 904) and storage unit 920 may store one or more sets of instructions and data structures (e.g., software) embodying or used by any one or more of the methodologies or functions described herein. These instructions (e.g., the instructions 902), when executed by processors 904, cause various operations to implement the disclosed examples.

The instructions 902 may be transmitted or received over the network 938, using a transmission medium, via a network interface device (e.g., a network interface component included in the communication components 936) and using any one of several well-known transfer protocols (e.g., hypertext transfer protocol (HTTP)). Similarly, the instructions 902 may be transmitted or received using a transmission medium via a coupling (e.g., a peer-to-peer coupling) to the devices 940.

### Software Architecture

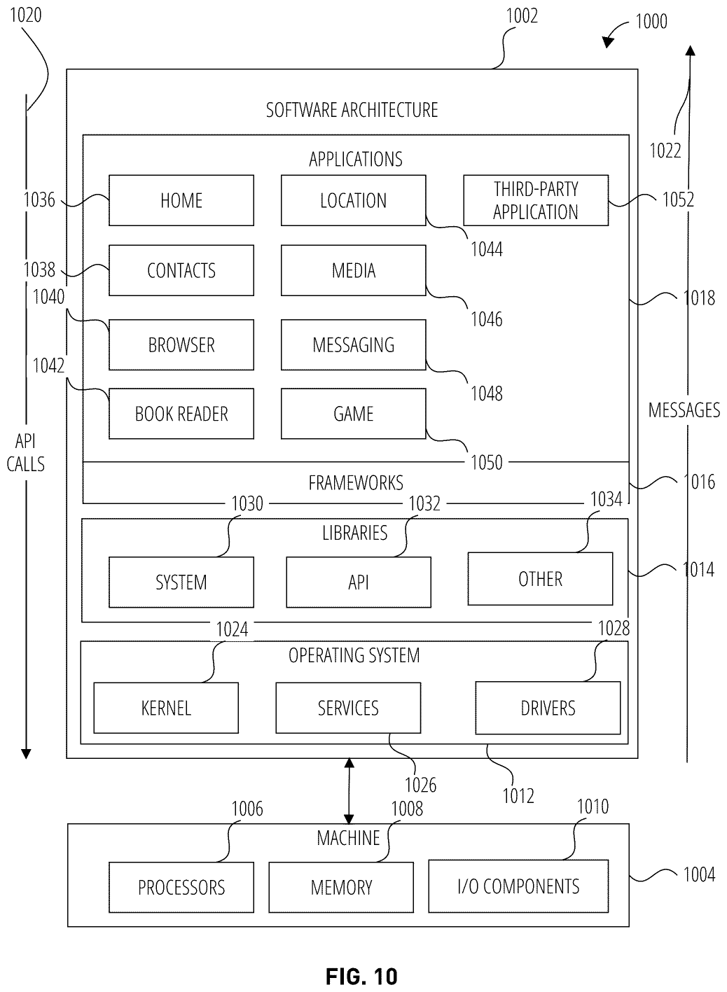

FIG. 10 is a block diagram 1000 illustrating a software architecture 1002, which can be installed on any one or more of the devices described herein. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such as an operating system 1012, libraries 1014, frameworks 1016, and applications 1018. Operationally, the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 provides memory management, processor management (e.g., scheduling), component management, networking, and security settings, among other functionalities. The services 1026 can provide other common services for the other software layers. The drivers 1028 are responsible for controlling or interfacing with the underlying hardware. For instance, the drivers 1028 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1014 provide a common low-level infrastructure used by the applications 1018. The libraries 1014 can include system libraries 1030 (e.g., C standard library) that provide functions such as memory allocation functions, string manipulation functions, mathematic functions, and the like. In addition, the libraries 1014 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1014 can also include a wide variety of other libraries 1034 to provide many other APIs to the applications 1018.

The frameworks 1016 provide a common high-level infrastructure that is used by the applications 1018. For example, the frameworks 1016 provide various graphical user interface (GUI) functions, high-level resource management, and high-level location services. The frameworks 1016 can provide a broad spectrum of other APIs that can be used by the applications 1018, some of which may be specific to a particular operating system or platform.

In an example, the applications 1018 may include a home application 1036, a contacts application 1038, a browser application 1040, a book reader application 1042, a location application 1044, a media application 1046, a messaging application 1048, a game application 1050, and a broad assortment of other applications such as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, or C++) or procedural programming languages (e.g., C or assembly language). In a specific example, the third-party application 1052 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1052 can invoke the API calls 1020 provided by the operating system 1012 to facilitate functionalities described herein.

### Further Examples Include

Example 1 is a method comprising: receiving, by one or more processors, a user query about a product from a user during a conversation with a chatbot; identifying, by the one or more processors, using the user query, one or more vendors that offer the product by searching product catalogs uploaded by vendors; determining, by the one or more processors, available inventory for the product across the one or more vendors by querying the product catalogs; generating, by the one or more processors, a natural language response to the user query using the identified vendors and available inventory information; and providing, by the one or more processors, the natural language response to the user during the conversation with the chatbot.

In Example 2, the subject matter of Example 1 includes, extracting, by the one or more processors, details about the product from the user query using natural language processing.

In Example 3, the subject matter of any of Examples 1-2 includes, wherein searching product catalogs comprises searching based on the extracted details about the product.

In Example 4, the subject matter of any of Examples 1-3 includes, ranking, by the one or more processors, the identified vendors based on one or more ranking factors.

In Example 5, the subject matter of any of Examples 1-4 includes, wherein the one or more ranking factors comprise: vendor relationship with a platform provider, product price, product availability, and shipping speed.

In Example 6, the subject matter of any of Examples 1-5 includes, recommending, by the one or more processors, additional products to the user based on analysis of the user query and user profile.

In Example 7, the subject matter of any of Examples 1-6 includes, updating, by the one or more processors, the user profile based on details extracted from the conversation with the chatbot.

In Example 8, the subject matter of any of Examples 1-7 includes, generating, by the one or more processors, using the user query and a user profile of the user, one or more incentives for a purchase of the product; and providing the one or more incentives to the user in the context of the conversation with the chatbot.

In Example 9, the subject matter of any of Examples 1-8 includes, wherein the one or more incentives are generated further using previous user queries.

In Example 10, the subject matter of any of Examples 1-9 includes, completing, by the one or more processors, a product purchase transaction for the product during the conversation with the chatbot.

Example 11 is at least one machine-readable medium including instructions that, when executed by processing circuitry, cause the processing circuitry to perform operations to implement of any of Examples 1-10.

Example 12 is a system to implement of any of Examples 1-10.

### Conclusion

Changes and modifications may be made to the disclosed examples without departing from the scope of the present disclosure. These and other changes or modifications are intended to be included within the scope of the present disclosure.

### GLOSSARY

“Carrier signal” refers to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an advertisement hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Machine-readable storage medium” refers to both machine-storage media and transmission media. Thus, the terms include both storage devices/media and carrier waves/modulated data signals. The terms “computer-readable medium,” “machine-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.” “Non-transitory machine-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

In this disclosure and appended claims, the terms “a” or “an” are used, as is common in patent documents, to include one or more than one, independent of any other instances or usages of “at least one” or “one or more. ” In this disclosure and appended claims, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the appended claims, the terms “including” and “comprising” are open-ended; that is, a system, device, article, or process that includes elements in addition to those listed after such a term in a claim is still deemed to fall within the scope of that claim.

What is claimed is:

1. A method comprising:
receiving a natural language user query during a conversation by a user with a chatbot, the natural language user query not explicitly providing details of a product;
determining one or more semantic clues about the product using natural language processing to extract product attributes from the natural language user query;
determining one or more product details of the product using the one or more semantic clues;
determining using the one or more product details, one or more tailored product recommendations of entities of an entity graph of the user by computationally analyzing one or more of a product browsing pattern and a query pattern of the entities of the entity graph to identify the one or more tailored product recommendations;
generating a natural language response to the natural language user query using the natural language user query, the one or more tailored product recommendations, the natural language response generated using a generative model that processes the natural language user query and the one or more tailored product recommendations to produce the natural language response; and
providing, by the chatbot, the natural language response during the conversation by the user with the chatbot, the natural language response including the one or more tailored product recommendations.

2. The method of claim 1, further comprising ranking the one or more tailored product recommendations based on ranking factors.

3. The method of claim 1, further comprising:
updating a user profile associated with the user based on the one or more semantic clues extracted from the natural language user query.

4. The method of claim 1, wherein determining the one or more product details comprises applying named entity recognition to identify product categories and attributes from the one or more semantic clues.

5. The method of claim 1, wherein determination of the one or more semantic clues comprises analyzing context from a conversation history of the user and the chatbot.

6. The method of claim 1, wherein the entity graph comprises connections between entities representing relationships determined from frequency of interactions.

7. The method of claim 1, wherein generating the natural language response comprises applying natural language processing techniques to synthesize a response based on the natural language user query and the one or more tailored product recommendations.

8. A machine comprising:
at least one processor; and
at least one memory storing instructions that, when executed by the at least one processor, cause the machine to perform operations comprising:
receiving a natural language user query during a conversation by a user with a chatbot, the natural language user query not explicitly providing details of a product;
determining one or more semantic clues about the product using natural language processing to extract product attributes from the natural language user query;
determining one or more product details of the product using the one or more semantic clues;
determining using the one or more product details, one or more tailored product recommendations of entities of an entity graph of the user by computationally analyzing one or more of a product browsing pattern and a query pattern of the entities of the entity graph to identify the one or more tailored product recommendations;
generating a natural language response to the natural language user query using the natural language user query, the one or more tailored product recommendations, the natural language response generated using a generative model that processes the natural language user query and the one or more tailored product recommendations to produce the natural language response; and
providing, by the chatbot, the natural language response during the conversation by the user with the chatbot, the natural language response including the one or more tailored product recommendations.

9. The machine of claim 8, wherein the operations further comprise ranking the one or more tailored product recommendations based on ranking factors.

10. The machine of claim 8, wherein the operations further comprise:
updating a user profile associated with the user based on the one or more semantic clues extracted from the natural language user query.

11. The machine of claim 8, wherein determining the one or more product details comprises applying named entity recognition to identify product categories and attributes from the one or more semantic clues.

12. The machine of claim 8, wherein determination of the one or more semantic clues comprises analyzing context from a conversation history of the user and the chatbot.

13. The machine of claim 8, wherein the entity graph comprises connections between entities representing relationships determined from frequency of interactions.

14. The machine of claim 8, wherein generating the natural language response comprises applying natural language processing techniques to synthesize a response based on the natural language user query and the one or more tailored product recommendations.

15. A machine-storage medium including instructions that, when executed by a machine, cause the machine to perform operations comprising:
receiving a natural language user query during a conversation by a user with a chatbot, the natural language user query not explicitly providing details of a product;
determining one or more semantic clues about the product using natural language processing to extract product attributes from the natural language user query;
determining one or more product details of the product using the one or more semantic clues;
determining using the one or more product details, one or more tailored product recommendations of entities of an entity graph of the user by computationally analyzing one or more of a product browsing pattern and a query pattern of the entities of the entity graph to identify the one or more tailored product recommendations;
generating a natural language response to the natural language user query using the natural language user query, the one or more tailored product recommendations, the natural language response generated using a generative model that processes the natural language user query and the one or more tailored product recommendations to produce the natural language response; and
providing, by the chatbot, the natural language response during the conversation by the user with the chatbot, the natural language response including the one or more tailored product recommendations.

16. The machine-storage medium of claim 15, wherein the operations further comprise ranking the one or more tailored product recommendations based on ranking factors.

17. The machine-storage medium of claim 15, wherein the operations further comprise:
updating a user profile associated with the user based on the one or more semantic clues extracted from the natural language user query.

18. The machine-storage medium of claim 15, wherein determining the one or more product details comprises applying named entity recognition to identify product categories and attributes from the one or more semantic clues.

19. The machine-storage medium of claim 15, wherein determination of the one or more semantic clues comprises analyzing context from a conversation history of the user and the chatbot.

20. The machine-storage medium of claim 15, wherein the entity graph comprises connections between entities representing relationships determined from frequency of interactions.
